(19) United States
(12) Patent Application Publication
(10) Pub. No.: US 2005/0233283 A1
(43) Pub. Date: Oct. 20, 2005

(54) Method and apparatus for oral appliance cleaning and storage

(76) Inventor: Nancy L. Clennon, Shrewsbury, MA (US)

Correspondence Address: EVELYN M. MARSHALL, ESQUIRE, 679 PLEASANT STREET, PAXTON, MA, 01612, US

(21) Appl. No.: 11/107,250

(22) Filed: Apr. 15, 2005

Related U.S. Application Data
(60) Provisional application No. 60/562,618, filed on Apr. 15, 2004.

(51) Int. Cl. A61C 17/00

(52) U.S. Cl. 433/216; 433/215; 433/80

(57) ABSTRACT

An apparatus and method of portably cleaning and storing oral appliances, providing the user with a low cost system, that may be inconspicuously and conveniently carried in a pocket, or other means, that is convenient to use, that is disposable, and has a high likelihood of use by teens as well as adults. The primary advantage of using the present invention is that the user will have the ability to store and clean their oral appliance in any location.

### CROSS-REFERENCE TO RELATED APPLICATIONS

This application depends from provisional application Ser. No. 60/562,618, filed Apr. 15, 2004. I incorporate said provisional application by reference as fully set forth.

### STATEMENT REGARDING FEDERALLY SPONSORED RESEARCH AND DEVELOPMENT

This invention has been created without the sponsorship or funding of any federally sponsored research or development program.

### REFERENCE TO A “MICROFICHE APPENDIX”

Not Applicable

### BACKGROUND OF THE INVENTION

1. Field of the Invention

The present invention relates generally to dental hygiene, and more specifically to a method and apparatus for oral appliance cleaning and storage.

2. Prior Art

Portable storage and/or cleaning devices have been developed, inter alia, to clean and/or freshen the mouth or an oral appliances and/or store said oral appliance. Said portable storage and cleaning devices clean and/or freshen the oral appliance and/or store said oral appliance for later use. Said portable storage and cleaning devices are typically in the form of a storage case with dentifrice and/or cleaning aids therein. Said portable storage and cleaning devices oftentimes include a cleaning/freshening liquid to clean/freshen said oral appliance, or a liquid, usually water, must be added to activate said cleaning/freshening agent to clean said oral appliance. Said portable storage and/or cleaning devices may be disposable and inexpensive or may be elaborate and more costly in design.

Although said portable storage and/or cleaning devices have been developed to store and/or clean and/or freshen oral appliances, there has not been a system specifically designed to store, clean, and freshen oral appliances that is low in cost to produce, that may be inconspicuously and conveniently carried in a pocket, or other means, that is disposable, that is convenient and easy to use and has a high likelihood of use by teens as well as adults. More specifically, portable storage and/or cleaning devices have not been developed in system form as to store and clean oral appliances as well as be disposable and convenient and desirable to teen users, thus leaving said oral appliance improperly stored and unclean prior to reuse.

Therefore, existing portable storage and/or cleaning devices and systems have drawbacks in environments where oral appliance removal/storage/reinsertion is required.

Firstly, the storage and/or cleaning devices do not provide a system that is conveniently and inconspicuously carried in the pocket or other means, and thus the potential user may not opt to use the storage and/or cleaning device because it is inconvenient to carry or conspicuous to others.

Secondly, the storage and/or cleaning devices do not provide a system that is convenient to use, and thus the potential user may not opt to use said storage and/or cleaning device because it is inconvenient to use.

Thirdly, the storage and/or cleaning devices may be costly to produce and thus less likely to be purchased and thus used.

There is therefore a need in the art for an apparatus and method of portably storing and/or cleaning oral appliances that is low in cost to produce, that may be inconspicuously and conveniently carried in a pocket, or other means, that is convenient to use, that is disposable, and has a high likelihood of use by teens as well as adults.

It is therefore a principal object of the present invention to provide a method and apparatus for portably storing and cleaning oral appliances that may be inconspicuously and conveniently carried in a pocket, or other means.

A further object of the present invention is to provide a method and apparatus for portable storing and cleaning of oral appliances that is easy to use.

A further object of the present invention is to provide a method and apparatus for portable storing and cleaning of oral appliances that is disposable.

A further object of the present invention is to provide a method and apparatus for portable storing and cleaning of oral appliances that is low in cost to produce.

With these and other objects in view, as will be apparent to those skilled in the art, the invention resides in the combination of parts set forth in the specification and covered by the claims appended hereto.

### BRIEF SUMMARY OF THE INVENTION

A novel approach to the portable cleaning and storing of oral appliances has now been discovered, thus providing the user with a low cost system, that may be inconspicuously and conveniently carried in a pocket, or other means, that is convenient to use, that is disposable, and has a high likelihood of use by teens as well as adults. By using the disclosed invention, the user will now enjoy a more inconspicuous, convenient and sanitary system for storing and cleaning oral appliances. The primary advantage of using the present invention is that the user will have the ability to store and clean their oral appliance in any location. The present invention will hereinafter be referred to as the Keep an' Clean System.

These and other objects will be apparent to those skilled in the art, along with advantages and features of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1A is a front perspective view of an embodiment of the Keep an' Clean system of the present invention;

FIG. 1B is a front perspective view of an embodiment of the Keep an' Clean system of the present invention; and

FIG. 2 is a side perspective view of an embodiment of the Keep an' Clean system of the present invention.

### NUMBERING OF THE DRAWINGS

2. Keep an' Clean System
4. Storage Pouch/Cleaning Cloth Pack Packaging
6. Cleaning Cloth Pack
8. Storage Pouch
8′. Storage Pouch Bottom
8″. Storage Pouch Side
8′″. Storage Pouch Top
10. Cleaning Cloth
12. Storage Pouch/Cleaning Cloth Pack Packaging Side A
14. Storage Pouch/Cleaning Cloth Pack Packaging Side B
16. Cleaning Cloth Pack Side A
18. Cleaning Cloth Pack Side B

### DETAILED DESCRIPTION OF THE INVENTION

In the broadest aspects, the present invention provides the skilled artisan with the analytical tools and technical know-how sufficient to make and use the disclosed invention. The present invention provides the user with a method and apparatus for oral appliance cleaning and storage.

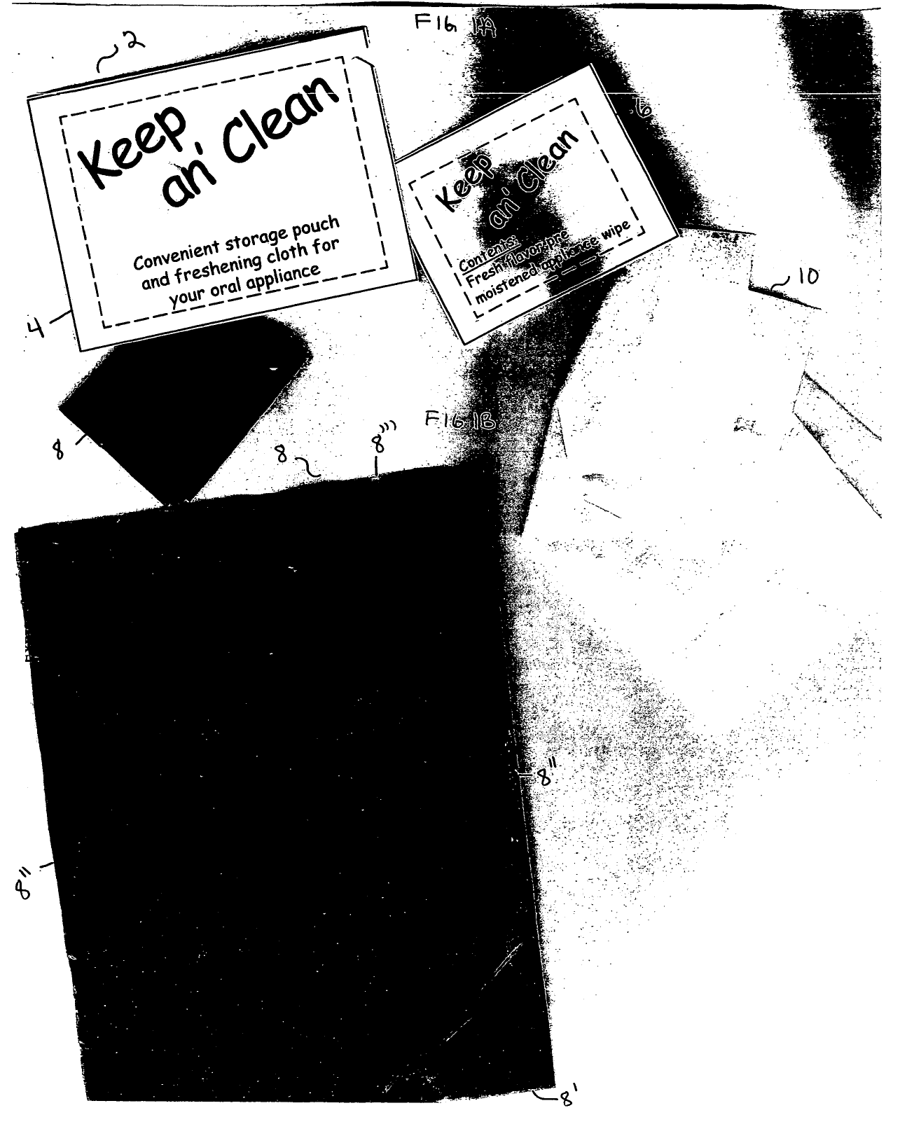

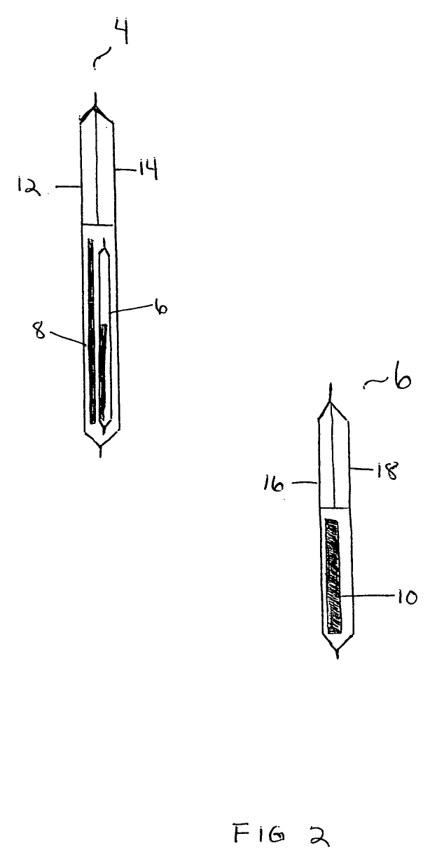

Referring to FIGS. 1A through 2, wherein like elements are indicated by like numerals, an embodiment of the present invention, in its most basic form, is generally indicated by the reference numeral 2, and comprises Storage Pouch/Cleaning Cloth Pack Packaging, generally indicated by reference numeral 4, Cleaning Cloth Pack, generally indicated by reference numeral 6, a Storage Pouch, generally indicated by reference numeral 8, and a cleaning cloth, generally indicated by reference numeral 10. The Keep an' Clean system is shown in its portable form in FIG. 1A and in functional form in FIG. 1B.

In further detail, in the preferred embodiment, said Keep an' Clean system 2 is comprised of Storage Pouch/Cleaning Cloth Pack Packaging 4, which contains Storage Pouch 8 and Cleaning Cloth Pack 6 sealed inside. In the preferred embodiment said Storage Pouch/Cleaning Cloth Pack Packaging 4 is approximately two and ½ inches in height and three and ¼ inches in width. Other sizes have been contemplated and may be determined by the size of said Storage Pouch 8 and said Cleaning Cloth Pack 6 and the oral appliance said Keep an' Clean system is to be used with. Said Storage Pouch/Cleaning Cloth Pack Packaging 4 and Cleaning Cloth Pack 6 are made of an airtight waterproof material such as poly-foil. Other equivalent substances would also be suitable. Identification of equivalents is well within the skill of the ordinary practitioner and would require no more than routine experimentation.

In the preferred embodiment, said Storage Pouch 8 is approximately five inches in width and six inches in height, and is made of polyethylene. Other equivalent substances would also be suitable. Identification of equivalents is well within the skill of the ordinary practitioner and would require no more than routine experimentation. Other sizes have been contemplated and may be determined by the size of the oral appliance said Keep an' Clean system is to be used with. Said Storage Pouch 8 is sealed on the Storage Pouch Bottom 8′ and the Storage Pouch Sides 8″. In portable form said Storage Pouch 8 is folded to be flatly sealed within said Storage Pouch Packaging 4, as is well known to one of ordinary skill in the art. Said Storage Pouch 8 may be selectively sealable via sealing means as is well known to one of ordinary skill in the art.

In the preferred embodiment, said Cleaning Cloth Pack 6 is approximately one and ¾ inches in height and two and ¼ inches in width. Cleaning Cloth 10 is approximately five inches in height and five inches in width, is made of a non-woven substrate and is moistened with an antiseptic cleaning agent. Other equivalent substances would also be suitable. Identification of equivalents is well within the skill of the ordinary practitioner and would require no more than routine experimentation. Furthermore, it is contemplated in other embodiments of the Keep an' Clean system and apparatus that said antiseptic cleaning agent includes sanitizing and whiting properties. Other sizes have been contemplated and may be determined by the size of the oral appliance said Keep an' Clean system is to be used with. In portable form said Cleaning Cloth 10 is folded to be flatly sealed within said Cleaning Cloth Pack 6, as is well known to one of ordinary skill in the art.

FIG. 2 shows a side view of said Storage Pouch/Cleaning Cloth Pack Packaging 4 and said Cleaning Cloth Pack 6 with said Storage Pouch 8 and said Cleaning Cloth 10, respectively, sandwiched between Storage Pouch/Cleaning Cloth Pack Packaging Side A 12 and Storage Pouch/Cleaning Cloth Pack Packaging Side B 14, and Cleaning Cloth Pack Side A 16 and Cleaning Cloth Pack Side B 18. As previously disclosed, said Storage Pouch/Cleaning Cloth Pack Packaging 4 and said Cleaning Cloth Pack 6 are made of a poly-foil material. Other equivalent means would also be suitable. Identification of equivalents is well within the skill of the ordinary practitioner and would require no more than routine experimentation.

In practice the system works as follows: The user tears open said Storage Pouch/Cleaning Cloth Pack Packaging 4, removes said Cleaning Cloth Pack 6 and Storage Pouch 8, unfolds said Storage Pouch 8 and places said oral appliance into said Storage Pouch 8 for storage. When the user is ready to reinsert said oral appliance into the oral cavity, the user tears open said Cleaning Cloth Pack 6, removes said Cleaning Cloth 10, unfolds said Cleaning Cloth 10 and wipes said oral appliance to clean said oral appliance before reinsertion into the oral cavity.

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes which come within the meaning and range of equivalency of the claims are therefore intended to be embraced herein.

1. A disposable oral appliance storage and cleaning assembly comprising:
a. a storage pouch;
b. a cleaning cloth;
c. storage pouch packaging; and
d. cleaning cloth packaging, wherein said storage pouch packaging houses said storage pouch and said cleaning cloth packaging houses said cleaning cloth.

2. The disposable oral appliance storage and cleaning assembly of claim 1, wherein said storage pouch packaging and said cleaning cloth packaging are coupled.

3. The disposable oral appliance storage and cleaning assembly of claim 1, wherein said storage pouch packaging and/or said cleaning cloth packaging is comprised of a rupturable fluid impervious material to maintain said storage pouch and said cleaning cloth until use.

4. The disposable oral appliance storage and cleaning assembly of claim 1, wherein said storage pouch is selectively sealable.

5. The disposable oral appliance storage and cleaning assembly of claim 1, wherein said cleaning cloth is moistened with a cleaning agent.

6. The disposable oral appliance storage and cleaning assembly of claim 1, wherein said storage pouch packaging's and/or said cleaning cloth packaging's containment area is sterile.

7. The disposable oral appliance storage and cleaning assembly of claim 5, wherein said cleaning agent is antiseptic.

8. A disposable oral appliance storage and cleaning assembly comprising:
a. a storage pouch;
b. a cleaning cloth;
c. storage pouch packaging; and
d. cleaning cloth packaging, wherein said storage pouch packaging houses said storage pouch and said cleaning cloth packaging houses said cleaning cloth.

9. The disposable oral appliance storage and cleaning assembly of claim 8, wherein said storage pouch packaging and said cleaning cloth packaging are coupled.

10. The disposable oral appliance storage and cleaning assembly of claim 9, where in said coupling results in the storage pouch packaging enveloping said cleaning cloth packaging.

11. The disposable oral appliance storage and cleaning assembly of claim 10, wherein said storage pouch packaging and/or said cleaning cloth packaging is comprised of a rupturable fluid impervious material to maintain said storage pouch and cleaning cloth until use.

12. The disposable oral appliance storage and cleaning assembly of claim 11, wherein said cleaning cloth is moistened with a cleaning agent.

13. The disposable oral appliance storage and cleaning assembly of claim 12, wherein said cleaning agent is antiseptic.

14. The disposable oral appliance storage and cleaning assembly of claim 13, wherein said storage pouch is comprised of polyethylene and is of the size to accommodate a standard oral appliance.

15. The disposable oral appliance storage and cleaning assembly of claim 14, wherein said cleaning cloth is comprises of a non-woven substrate.

16. The disposable oral appliance storage and cleaning assembly of claim 15, wherein said storage pouch is folded within said storage pouch packaging and said cleaning cloth is folded with said cleaning cloth packaging and collectively is of the size to comfortably fit into a pocket or purse.

17. The disposable oral appliance storage and cleaning assembly of claim 16, wherein said storage pouch packaging's and/or said cleaning cloth packaging's containment area is sterile.

18. The disposable oral appliance storage and cleaning assembly of claim 17, wherein said storage pouch packaging is approximately two and one half inches in height and three and one quarter inches in width.

19. The disposable oral appliance storage and cleaning assembly of claim 18, wherein said storage pouch packaging is approximately one and three quarters inches in height and two and three quarter inches in width.

20. A method of storing and cleaning an oral appliance comprising the steps of:
a. Removing said oral appliance from the oral cavity;
b. Tearing open the storage pouch packaging;
c. Removing the storage pouch from the storage pouch packaging;
d. Unfolding said storage pouch;
e. Placing said oral appliance in said storage pouch;
f. Removing said oral appliance from said storage pouch when termination of storage is desired;
g. Tearing open the cleaning cloth packaging;
h. Removing the cleaning cloth from said cleaning cloth packaging;
i. Cleaning said oral appliance with said cleaning cloth; and
j. Reinserting said oral appliance into the oral cavity.
